(19) United States
(12) Patent Application Publication
(10) Pub. No.: US 2026/0082928 A1
(43) Pub. Date: Mar. 19, 2026

(54) TAMPER-RESISTANT MICROELECTRONIC CIRCUIT PACKAGES

(71) Applicant: Sandisk Technologies, Inc., Milpitas, CA (US)

(72) Inventor: Daniel BEDAU, San Jose, CA (US)

(73) Assignee: Sandisk Technologies, Inc., Milpitas, CA (US)

(21) Appl. No.: 18/886,576

(22) Filed: Sep. 16, 2024

(51) Int. Cl. H01L 23/00; G06F 21/86; H01L 21/56; H01L 23/31

(52) U.S. Cl. CPC H10W 42/405; G06F 21/86; H10W 74/01; H10W 74/134; H10W 74/147

(57) ABSTRACT

A microelectronic circuit package may include one or more operative channels, each of the one or more operative channels containing a reactive material, and a seal covering at least a portion of the one or more operative channels. At least one of the one or more operative channels has a maximum width of less than about 100 microns. The seal is non-reactive with the reactive material. Also disclosed are methods of manufacturing a microelectronic circuit package comprising at least one operative channel containing a reactive material.

### BACKGROUND

Preventing the reverse engineering of chips is of interest for a variety of reasons. For example, companies invest significant resources in developing innovative technologies, and reverse engineering allows competitors to copy these innovations without incurring the development costs, which can lead to potential loss of revenue and market share for the company that developed the technologies. Competitors may produce cheaper clones of a product, leveraging the original company's research and development without bearing the associated costs, thus undercutting prices and market share.

In addition, chips can include proprietary algorithms, design methodologies, and unique processes, and protecting these trade secrets helps maintain a company's competitive edge. By preventing reverse engineering, companies can protect their innovations from being replicated by competitors, allowing the company that invested in the development to capitalize on its investments.

Reverse engineering can also expose vulnerabilities in hardware and software, making it easier for malicious actors to exploit these vulnerabilities. The result can lead to unauthorized data access, data breaches, and other security threats. Some chips are used in critical infrastructure, such as telecommunications, healthcare, and defense, and ensuring these chips are secure from reverse engineering helps protect national security and public safety.

Certain industries, such as defense and healthcare, have strict regulatory requirements regarding the security and integrity of hardware and software. Preventing reverse engineering of chips used in these industries helps companies comply with regulations. In addition, technologies with potential military applications are often subject to export controls. Preventing reverse engineering helps ensure that these technologies are not wrongfully exported.

Protecting chips from reverse engineering also helps ensure that the company making those chips retains its revenue streams from sales and licensing. Unauthorized copies can lead to significant financial losses. Furthermore, a company's reputation can be damaged if its products are easily cloned or if vulnerabilities are exposed through reverse engineering. Maintaining robust protection measures helps preserve brand integrity.

To frustrate reverse engineering attempts, manufacturers may use a variety of techniques to make analyzing a chip's internal components difficult, time-consuming, and/or costly. For example, tamper-proof enclosures (encasing the chip in packaging that shows visible evidence of tampering attempts) can deter physical attacks, as can encasing a chip in a potting compound (a solid, non-removable material can prevent access to the internal portion of the chip). In many situations, however, a reverse engineer has full control of the chip (e.g., by purchasing a product that contains the chip), and techniques such as encasing the chip in packaging that shows visible evidence of tampering attempts are ineffective to deter reverse engineering attempts.

Furthermore, many conventional physical protection techniques that attempt to obscure the chip from view can be defeated relatively easily. For example, although encasing a chip in plastic and/or applying a hard, opaque epoxy coating over the chip makes physical access and optical inspection more difficult, a strong nitric acid or sulfuric acid can typically be used to remove the plastic and/or epoxy coating without damaging the electronics, thereby allowing the chip to be inspected.

Thus, there is a need for new and improved approaches to prevent or hamper tampering efforts and the reverse engineering of chips.

### SUMMARY

This summary represents non-limiting embodiments of the disclosure.

In some aspects, the techniques described herein relate to a microelectronic circuit package, including: one or more operative channels, each of the one or more operative channels containing a reactive material, wherein at least one of the one or more operative channels has a maximum width of less than about 100 microns; and a seal covering at least a portion of the one or more operative channels, wherein the seal is non-reactive with the reactive material.

In some aspects, the reactive material is reactive with at least one of nitric acid, sulfuric acid, oxygen, or water.

In some aspects, the reactive material includes at least one of Li, Na, K, Rb, or Cs.

In some aspects, the reactive material includes an organolaluminum compound of a form A12X6, wherein X is a methyl or ethyl group.

In some aspects, the reactive material is conductive, and the microelectronic circuit package further includes wiring, wherein the reactive material in at least one of one or more operative channels is included in the wiring.

In some aspects, at least one of the one or more operative channels is included in an integrated circuit chip of the microelectronic circuit package.

In some aspects, at least one of the one or more operative channels is separate from an integrated circuit chip of the microelectronic circuit package.

In some aspects, the seal includes at least one of stainless steel, nickel, tantalum, titanium, molybdenum, glass, graphite, alumina, silicon carbide, an inert plastic, or encapsulant material.

In some aspects, the microelectronic circuit package further includes: at least one sensor to sense a characteristic of the reactive material in at least one of the one or more operative channels; and a processor coupled to the at least one sensor and configured to: obtain from the at least one sensor an indication of the sensed characteristic, determine, based at least in part on the indication of the sensed characteristic, that the characteristic of the reactive material in the at least one of the one or more operative channels has changed, and in response to the determination that the characteristic of the reactive material in the at least one of the one or more operative channels has changed, take an action.

In some aspects, the characteristic is at least one of a resistance of the reactive material, a capacitance of the reactive material, a dielectric property of the reactive material, a presence of at least one random feature in the reactive material, or a configuration of the at least one random feature in the reactive material.

In some aspects, the at least one random feature includes one or more bubbles and/or one or more particles.

In some aspects, the action includes at least one of: abort a start-up procedure, prevent execution of code, prevent booting, erase or overwrite data, disable a function of an integrated circuit chip of the microelectronic circuit package, disable the integrated circuit chip, disable a communication interface of the integrated circuit chip, or blow a hardware fuse of the integrated circuit chip.

In some aspects, the microelectronic circuit package further includes: at least one sensor to sense a characteristic of the reactive material in at least one of the one or more operative channels; and a processor coupled to the at least one sensor and configured to: obtain from the at least one sensor an indication of the sensed characteristic, based at least in part on the indication of the sensed characteristic, derive a cryptographic key usable to protect data to be stored in the microelectronic circuit package or access to the microelectronic circuit package.

In some aspects, the processor is further configured to: decrypt data stored in the microelectronic circuit package using the cryptographic key.

In some aspects, the characteristic is at least one of a resistance of the reactive material, a capacitance of the reactive material, a dielectric property of the reactive material, a presence of at least one random feature in the reactive material, or a configuration of the at least one random feature in the reactive material.

In some aspects, the at least one random feature includes one or more bubbles and/or one or more particles.

In some aspects, the at least one sensor includes a sensor array situated along a length of the at least one of the one or more operative channels.

In some aspects, the characteristic is a presence of a plurality of random features in the reactive material, or a configuration of the plurality of random features in the reactive material.

In some aspects, plurality of random features includes a plurality of bubbles and/or a plurality of particles.

In some aspects, each of the one or more operative channels is lined with a protective material, the protective material being non-reactive with the reactive material.

In some aspects, the reactive material includes NaK or RbCs, and the protective material includes stainless steel, nickel, tantalum, titanium, molybdenum, glass, graphite, alumina, silicon carbide, or an inert plastic.

In some aspects, the microelectronic circuit package further includes: one or more decoy channels, each of the one or more decoy channels having a size and shape substantially identical to a size and shape of each of the one or more operative channels, wherein the seal covers at least one end of each of the one or more decoy channels.

In some aspects, the one or more decoy channels are unfilled, and at least one of the one or more decoy channels is configured to cause a short circuit in response to being filled with a conductive material.

In some aspects, at least one of the one or more decoy channels is filled with a second material.

In some aspects, the second material includes a conductor, and further including wiring, wherein the second material in the at least one of the one or more decoy channels is included in the wiring.

In some aspects, the techniques described herein relate to a method of manufacturing a microelectronic circuit package including at least one operative channel containing a reactive material, the method including: creating the at least one operative channel in a work-in-progress microelectronic circuit package, wherein a maximum width of the at least one operative channel is less than about 100 microns; directing the reactive material into the at least one operative channel; and sealing an exposed portion of the at least one operative channel, thereby covering at least some of the reactive material with a seal.

In some aspects, the seal includes at least one of stainless steel, nickel, tantalum, titanium, molybdenum, glass, graphite, alumina, silicon carbide, an inert plastic, or encapsulant material.

In some aspects, wherein directing the reactive material into the at least one operative channel is performed using a sprue region of the microelectronic circuit package, and the method further includes: creating the sprue region; and after directing the reactive material into the at least one operative channel, removing the sprue region from the work-in-progress microelectronic circuit package at a shear line, thereby leaving an exposed surface, and wherein sealing the exposed portion of the at least one operative channel includes applying the seal to the exposed surface.

In some aspects, the reactive material is conductive.

In some aspects, the reactive material includes at least one of Li, Na, K, Rb, or Cs.

In some aspects, the method further includes placing the work-in-progress microelectronic circuit package in a low-oxygen and/or low-humidity environment before directing the reactive material into the at least one operative channel.

In some aspects, sealing the exposed portion of the at least one operative channel is performed while the work-in-progress microelectronic circuit package is in the low-oxygen and/or low-humidity environment.

In some aspects, creating the at least one operative channel includes: etching the at least one operative channel in the work-in-progress microelectronic circuit package.

In some aspects, the method further includes: depositing a layer of protective material over an interior surface of the at least one operative channel.

In some aspects, the protective material is non-reactive with the reactive material.

In some aspects, the reactive material is NaK or RbCs, and the protective material includes one or more of stainless steel, nickel, tantalum, titanium, molybdenum, glass, graphite, alumina, silicon carbide, or an inert plastic.

In some aspects, the method further includes: creating one or more decoy channels in the work-in-progress microelectronic circuit package, wherein each of the one or more decoy channels is non-intersecting with the at least one operative channel; and sealing an exposed portion of the one or more decoy channels.

In some aspects, the method further includes: depositing a layer of protective material over an interior surface of the at least one of the one or more decoy channels.

In some aspects, the protective material is non-reactive with the reactive material.

In some aspects, the reactive material is NaK or RbCs, and the protective material includes one or more of stainless steel, nickel, tantalum, titanium, molybdenum, glass, graphite, alumina, silicon carbide, or an inert plastic.

In some aspects, the method further includes: before sealing the exposed portion of the one or more decoy channels, directing a second material into at least one of the one or more decoy channels.

In some aspects, the second material is conductive.

### BRIEF DESCRIPTION OF THE DRAWINGS

Objects, features, and advantages of the disclosure will be readily apparent from the following description of certain embodiments taken in conjunction with the accompanying drawings in which:

FIG. 1A is a cross-section of an example of a microelectronic circuit package that, in accordance with some embodiments, can include one or more of the techniques described herein.

FIG. 1B is an illustration of a portion of a microelectronic circuit package in accordance with some embodiments.

FIG. 2A is an illustration of a cross-section of a portion of an example of a die that includes at least one operative channel in accordance with some embodiments.

FIG. 2B is an illustration of a cross-section of a portion of an example of a die in which protective material lines the interior of an operative channel in accordance with some embodiments.

FIG. 3A illustrates an example of a microelectronic circuit package that includes a die that has three operative channels and two decoy channels in accordance with some embodiments.

FIG. 3B is an illustration of an example die in which the at least one decoy channel is filled by a second material in accordance with some embodiments.

FIG. 4A illustrates an example technique for creating the microelectronic circuit package shown in FIG. 3A in accordance with some embodiments.

FIG. 4B is cross-section view at the shear line of the microelectronic circuit package example shown in FIG. 4A.

FIG. 5A is a top view of a portion of the microelectronic circuit package in accordance with some embodiments.

FIG. 5B shows how removing the reactive material from the at least one operative channel can adversely affect the power connections of the microelectronic circuit package in accordance with some embodiments.

FIG. 5C is an illustration of how filling the at least one decoy channel with reactive material or another conductor can cause the microelectronic circuit package to fail in accordance with some embodiments.

FIG. 5D is an example of a microelectronic circuit package in which at least one operative channel is situated in the encapsulant in accordance with some embodiments.

FIG. 5E is an example of a microelectronic circuit package in which an operative channel replaces one of the bonding wires in accordance with some embodiments.

FIG. 6A is an example of components that can be used to detect changes in one or more of the at least one operative channel and/or in one or more of the at least one decoy channel in accordance with some embodiments.

FIG. 6B is an example of a sensor array situated along an operative channel in accordance with some embodiments.

FIG. 7A is a flow diagram illustrating a method of manufacturing a microelectronic circuit package that includes at least one operative channel in accordance with some embodiments.

FIG. 7B is a flow diagram of a method that can be performed to accomplish a block of the method of FIG. 7A in accordance with some embodiments.

FIG. 7C is a flow diagram of a method that can be performed to accomplish an optional block of the method 200 of FIG. 7A in accordance with some embodiments.

To facilitate understanding, identical reference numerals have been used, where possible, to designate identical elements that are common to the figures. It is contemplated that elements disclosed in one embodiment may be beneficially utilized in other embodiments without specific recitation. Moreover, the description of an element in the context of one drawing is applicable to other drawings illustrating that element.

Some of the drawings herein illustrate multiple instances of a feature, with each feature designated by a reference numeral followed by a different letter. For convenience, the detailed description sometimes refers to features collectively (e.g., at least one decoy channel 102, at least one operative channel 105, sensors 140, etc.) using only the reference numeral.

### DETAILED DESCRIPTION

As explained above, preventing the reverse engineering of chips is of interest for a variety of reasons, such as to protect intellectual property, ensure security, maintain competitive advantage, and comply with regulations. Reverse engineering often involves chip decapping, which is the process of removing the encapsulating material from a packaged integrated circuit (IC) to expose its internal components, such as a silicon die and bonding wires. There are several methods of chip decapping. Acid decapping involves the use of strong acids, such as nitric acid, sulfuric acid, or a mixture of both, to dissolve the plastic or epoxy encapsulation. Mechanical decapping techniques can also be used. Mechanical tools such as grinders, mills, or sandblasters can be used to remove the encapsulant material. Laser decapping involves the use of a laser to selectively ablate the encapsulating material. Thermal decapping subjects the chip to rapid temperature changes to crack and remove the encapsulant.

Once a chip has been decapped, a visual inspection (e.g., using optical microscopes or scanning electron microscopes (SEM)) can be performed to inspect the exposed die and bonding wires. Electrical testing can also be performed to assess the functionality of the exposed components.

Disclosed herein are techniques for hampering or preventing the reverse engineering of chips. The disclosed techniques use at least one long, narrow channel created in a microelectronic circuit package (e.g., in a die, over a die, in the encapsulant material itself, etc.) and filled with a reactive material (e.g., a liquid or solid) that reacts violently with oxygen and/or water. Ideally, tampering attempts in the presence of oxygen or water cause the reactive material to damage or destroy the chip. In some embodiments, the reactive material also reacts violently with the chemicals commonly used to decap chips (e.g., nitric acid, sulfuric acid, etc.). In some embodiments, the reactive material comprises at least one of Li, Na, K, Rb, or Cs. In some embodiments, the reactive material comprises an organolaluminum compound of a form A12X6, wherein X is a methyl or ethyl group.

The dimensions of the at least one channel can be selected so that it would be difficult or impossible for a reverse engineer to refill the channel if he were to successfully remove the reactive material from the microelectronic circuit package. For example, the at least one channel can have a maximum width of 100 microns or less to discourage refilling.

In some embodiments, the reactive material is conductive and is included in the wiring used by the microelectronic circuit package (e.g., for power and/or signals), so that if the reactive material is removed, circuitry within the microelectronic circuit package stops working. In some embodiments, a characteristic of the reactive material (e.g., its resistance, its capacitance, a dielectric property of the reactive material, a pattern in the reactive material (e.g., positions of detectable particles in the reactive material), etc.) is used to detect tampering. In some embodiments, a characteristic of the reactive material (e.g., its resistance, its capacitance, a dielectric property of the reactive material, a pattern in the reactive material (e.g., positions of detectable particles in the reactive material), etc.) is used to derive a unique cryptographic key for the microelectronic circuit package. In some embodiments, the cryptographic key is used to encrypt and/or decrypt data stored in the microelectronic circuit package.

In some embodiments, the microelectronic circuit package also includes one or more decoy channels. In some embodiments, the one or more decoy channels are empty (unfilled). In some embodiments, the one or more decoy channels are filled. In some embodiments, the one or more decoy channels are arranged such that if they are filled with a conductive material (e.g., if a reverse engineer attempts to refill the channels that originally held reactive material), they cause damage to the circuitry of the microelectronic circuit package.

The term “microelectronic circuit package” is used herein to refer to any packaged circuit that includes at least one integrated circuit (IC) and some kind of interface or interfaces (e.g., leads, pins, at least one contact pad, an antenna, etc.) that allow the IC to interface with an external component, such as a printed circuit board (PCB), a card reader, etc. Microelectronic circuit packages can be, for example and without limitation, any of the following: a dual in-line package (DIP), a surface-mount package (SMP) (e.g., SOIC, QFP, BGA), a chip-scale package (CSP), a multi-chip module (MCM), a flip-chip package, a memory card (e.g., SD card), a smart card, etc. Microelectronic circuit packages can use a variety of packaging technologies, including, for example and without limitation, through-hole technology, surface-mount technology, three-dimensional packaging, system-in-package (SiP) packaging, wafer-level packaging, etc.

The term “work-in-progress microelectronic circuit package” is used herein to refer to a microelectronic circuit package that is not complete in some respect. For example, a work-in-progress microelectronic circuit package may be at some stage of the manufacturing process. Thus, the work-in-progress microelectronic circuit package will eventually be a complete microelectronic circuit package, but it has not been completed.

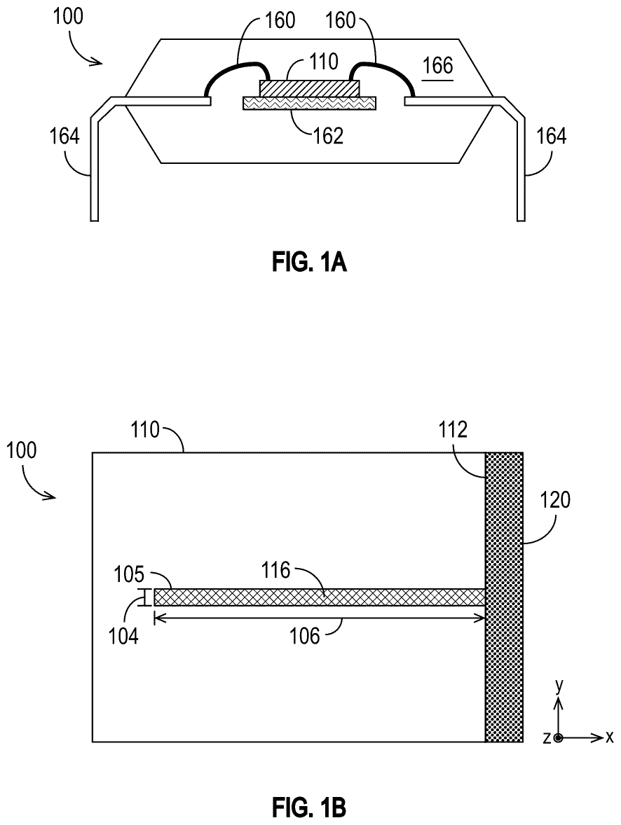

FIG. 1A is a cross-section of an example of a microelectronic circuit package 100 that can include some or all of the techniques described herein in accordance with some embodiments. As explained above, the microelectronic circuit package 100 is a structure that comprises one or more ICs and other electronic components, including pins that facilitate connecting the microelectronic circuit package 100 to external circuitry or components. Among other things, the microelectronic circuit package 100 provides a stable environment and protects the IC(s) from physical damage and environmental hazards.

The microelectronic circuit package 100 example shown in FIG. 1A includes a die 110, bonding wires 160, a substrate 162, leads 164, and encapsulant 166. The die 110 is a semiconductor die (which can also be referred to as a chip or an IC) that is a principal component of the microelectronic circuit package 100. The die 110 contains at least one IC and performs electronic functions (e.g., one or more of processing, memory storage, signal amplification, etc.). Although FIG. 1A shows a single die 110, it is to be appreciated that the microelectronic circuit package 100 can include multiple dies 110. Thus, the microelectronic circuit package 100 includes at least one IC and potentially multiple ICs.

The die 110 shown in FIG. 1A is mounted to a substrate 162 (e.g., using a die attach material such as a silver-filled epoxy, solder, or other conductive adhesive(s)). The substrate 162 is a base layer that supports the die 110 and provides mechanical stability. The substrate 162 acts as a platform for mounting the die 110 and can serve as a medium for electrical connections between the die 110 and external circuitry (e.g., power, signal sources and/or destinations, etc.). Common materials for the substrate 162 are, for example, FR4 (a type of fiberglass), ceramic, metal-core substrates, etc.

The microelectronic circuit package 100 example shown in FIG. 1A also includes bonding wires 160. The bonding wires 160 are wires or other materials that provide electrical connections between the die 110 and the leads 164. The bonding wires 160 are typically made from gold, aluminum, or copper. In the illustrated example, the leads 164 are metal projections extending from the encapsulant 166 that provide external connections. In some embodiments, the leads 164 allow the microelectronic circuit package 100 to be soldered onto a PCB and facilitate electrical connections to the external circuitry. In some embodiments, the leads 164 allow the microelectronic circuit package 100 to be powered. Typical materials for the leads 164 include copper or a copper alloy, which may be plated with tin, gold, or nickel. The leads 164 can take many forms, including pins, balls, or any other mechanism that allows electrical connections to the microelectronic circuit package 100. For example, when the microelectronic circuit package 100 is a ball grid array (BGA), the leads 164 can be solder balls. As another example, when the microelectronic circuit package 100 is a flip-chip, the leads 164 can be solder bumps that provide direct electrical connections between the die 110 and the substrate 162.

The microelectronic circuit package 100 shown in FIG. 1A also includes encapsulant 166, which is a protective layer that surrounds the die 110 and bonding wires 160. The encapsulant 166 protects the die 110 and bonding wires 160 from physical damage, moisture, and contaminants, and it can also provide heat sinking. The encapsulant 166 is typically made from an epoxy resin, silicone, or another molding compound. A reverse engineer may try to remove the encapsulant 166 using substances such as nitric acid or sulfuric acid.

It is to be appreciated that the microelectronic circuit package 100 may include additional components or features not illustrated in FIG. 1A. For example, the microelectronic circuit package 100 may include a lead frame, which is a metal frame within the microelectronic circuit package 100 that supports the die and provides electrical connections. If present, the lead frame may be made of copper, copper alloys, or sometimes a combination of metals. In addition or alternatively, the microelectronic circuit package 100 may include a dedicated heat sink (or heat spreader) to conduct heat generated by the die 110 away from the die 110 during operation. Alternatively or in addition, the microelectronic circuit package 100 can include underfill, which is a material (typically an epoxy resin) applied between the die 110 and the substrate 162 in flip-chip packages to enhance mechanical stability and thermal performance by filling gaps and reducing stress on solder joints. Alternatively or in addition, the microelectronic circuit package 100 can include a passivation layer, which is a protective coating (e.g., silicon dioxide (SiO₂), silicon nitride (Si₃N₄), or polyimide) applied to the surface of the die 110 to enhance stability and protect the surface of the die 110 from contaminants and physical damage.

It is to be appreciated that, as explained above, there are many types of microelectronic circuit packages. The disclosures are not limited to use only with the examples of microelectronic circuit packages shown and described herein. The disclosures are also not limited to microelectronic circuit packages that are (or are configured to be) soldered to a PCB. For example, the techniques shown and described herein can be applied to other types of microelectronic circuit packages, such as memory cards (e.g., SSD cards), smart cards, or any other microelectronic circuit package that contains one or more integrated circuits.

FIG. 1B is an illustration of a portion of a microelectronic circuit package 100 in accordance with some embodiments. FIG. 1B illustrates a die 110 and a seal 120. Using the example rectangular axes shown in FIG. 1B, the microelectronic circuit package 100 can be mounted to a PCB that has a component (i.e., populated) surface that lies in an x-y plane. Thus, the view in FIG. 1B is from the top and depicts the interior of a portion (certain components on/in the die 110) of the microelectronic circuit package 100.

In some embodiments, the die 110 comprises at least one operative channel 105. At least one operative channel 105 may be included in an IC of the microelectronic circuit package 100, or at least one operative channel 105 can be separate from an IC of the microelectronic circuit package 100. The at least one operative channel 105 extends to an edge surface 112 of the die 110 and is filled with a reactive material 116, which is discussed in detail below. In some embodiments, the reactive material 116 is a liquid at room temperature.

A characteristic of the at least one operative channel 105 is that, in the finished microelectronic circuit package 100, it has dimensions (e.g., width, length, height) such that if a reverse engineer manages to remove the reactive material 116 from the at least one operative channel 105, it will be difficult or impossible for the reverse engineer to refill the at least one operative channel 105. As will be appreciated by those having ordinary skill in the art, the difficulty of filling the at least one operative channel 105 is influenced by the width of the at least one operative channel 105, surface tension and viscosity of the liquid filling the channel (e.g., the reactive material 116), and the wettability of the walls of the at least one operative channel 105. Generally, as the width of a fluidic channel decreases, the capillary forces and viscous resistance become more significant, making it more challenging to fill the channel. For example, the cohesive forces between liquid molecules create surface tension, which can cause resistance to flow in narrow channels. For narrow and/or shallow channels, the relative contribution of viscous forces increases, leading to greater resistance to flow. Therefore, the narrower the at least one operative channel 105 is, the greater are the capillary and viscous forces that must be overcome to fill the at least one operative channel 105. Channels with sub-millimeter widths/diameters can exhibit significant filling challenges. Techniques for filling the at least one operative channel 105 during the manufacturing process to overcome these challenges are described below.

Accordingly, in some embodiments, the at least one operative channel 105 is narrow enough that capillary forces and viscous resistance are significant enough to discourage refilling attempts for the completed microelectronic circuit package 100. As shown in FIG. 1B, in some embodiments, the at least one operative channel 105 has a length 106 and a maximum width 104. In some embodiments, the maximum width 104 of the at least one operative channel 105 is less than about 1 mm. In some embodiments, the maximum width 104 is less than about 100 μm. In some embodiments, the at least one operative channel 105 is significantly longer than it is wide. In some embodiments, the length 106 of the at least one operative channel 105 is at least 10 times the maximum width 104 of the at least one operative channel 105.

In the example illustrated in FIG. 1B, a seal 120 covers the edge surface 112 of the die 110 and prevents the reactive material 116 from being exposed to oxygen and/or water (e.g., humidity). The seal 120 is made of a material that is non-reactive with the reactive material 116. For example, if the reactive material 116 is NaK or RbCs, both of which are discussed further below, the seal 120 can be made of (or comprise) one or more of stainless steel, nickel, a nickel alloy, tantalum, titanium, molybdenum, glass, graphite, alumina (also referred to as aluminum oxide, Al₂O₃), silicon carbide, an inert plastic (e.g., polytetrafluoroethylene (PTFE), polyetheretherketone (PEEK), etc.), encapsulant 166 material, or similar. In some embodiments, the seal 120 is opaque, preventing the edge surface 112 and the at least one operative channel 105 from being visible while the seal 120 is intact. Thus the seal 120 can hide the at least one operative channel 105 from view if the die 110 becomes visible to a reverse engineer.

In some embodiments, the reactive material 116 is a material that reacts with oxygen, water, or both, such that if the seal 120 is removed from the edge surface 112, the reactive material 116 reacts in a manner that damages some or all of the microelectronic circuit package 100 and/or causes some or all of the microelectronic circuit package 100 to stop working in part or in full, as described further below. In some embodiments, the reactive material 116 is reactive with chemicals commonly used to decap chips (e.g., nitric acid, sulfuric acid, etc.). In some embodiments, the reactive material 116 comprises at least one of Li, Na, K, Rb, or Cs. For example, the reactive material 116 can be an alloy that contains at least one of Li, Na, K, Rb, or Cs. In some embodiments, the reactive material 116 comprises an organolaluminum compound of a form A12X6, wherein X is a methyl or ethyl group.

In some embodiments, the reactive material 116 is a sodium-potassium alloy, which is referred to as “a Nak alloy” or simply “NaK.” Typically, a NaK alloy has a composition of around 78% potassium and 22% sodium by weight, which results in a eutectic mixture with a melting point of approximately −12.6° C. (9.3° F.). Thus, NaK is in a liquid state at room temperature.

Both sodium and potassium are highly reactive alkali metals. NaK is also highly reactive, particularly with water and oxygen, producing hydrogen gas and heat, which can lead to fires or explosions. NaK can ignite spontaneously upon contact with air due to the potassium component. NaK also reacts violently with nitric acid and sulfuric acid, which are chemicals commonly used to decap chips. To avoid ignition, NaK can be handled in an inert atmosphere (such as argon or nitrogen).

Nak is also highly conductive. As a liquid metal, it has free electrons that facilitate the conduction of electricity. Accordingly, in some embodiments, NaK as the reactive material 116 in one or more of the at least one operative channel 105 conducts current to carry signals and/or power within the microelectronic circuit package 100. In other words, in some embodiments, one or more of the at least one operative channel 105 are integral to the signal and/or power pathways of the microelectronic circuit package 100.

In some embodiments, the reactive material 116 is a rubidium-cesium alloy, referred to as “an RbCs alloy” or simply “RbCs.” Both rubidium and cesium are alkali metals, and, when combined, they form a liquid alloy at room temperature due to their low melting points. An RbCs alloy can have various compositions, but a common eutectic mixture is approximately 72% cesium and 28% rubidium by weight, which has a melting point of around −78° C. (−108.4° F.). Thus, like NaK, RbCs is in a liquid state at room temperature.

Both rubidium and cesium are highly reactive alkali metals. The RbCs alloy inherits this reactivity, particularly with water and oxygen. RbCs can ignite spontaneously when exposed to air and react explosively with water. RbCs also reacts violently with nitric acid and sulfuric acid, two of the chemicals commonly used to decap chips. To avoid ignition, RbCs can be handled in an inert atmosphere.

Like NaK, RbCs is conductive and retains the conductive properties of its rubidium and cesium constituent metals, allowing for efficient electrical conduction. Accordingly, in some embodiments, RbCs as the reactive material 116 in one or more of the at least one operative channel 105 conducts current to carry signals and/or power within the microelectronic circuit package 100. In other words, in some embodiments, one or more of the at least one operative channel 105 are integral to the signal and/or power pathways of the microelectronic circuit package 100.

In some embodiments, the reactive material 116 is selected such that it is non-reactive with whatever materials in the microelectronic circuit package 100 are in contact with the reactive material 116. In this case, the at least one operative channel 105 can be created, for example, in a die 110, and the reactive material 116 can be added directly to the at least one operative channel 105 during the manufacturing process without any protective barrier in the at least one operative channel 105. For example, silicon, silicon dioxide, silicon nitride, polysilicon, tungsten, titanium nitride, and tantalum are generally non-reactive with NaK and RbCs. Thus, in some embodiments, the at least one operative channel 105 is fabricated (e.g., by etching) directly in one or more layers of a die 110, and the reactive material 116 (e.g., NaK or RbCs) is then in direct contact with one or more of the materials used in the die 110. Alternatively or in addition, the at least one operative channel 105 can be created in another region of the microelectronic circuit package 100 that is made from a material that is non-reactive with the reactive material 116 (e.g., the encapsulant 166).

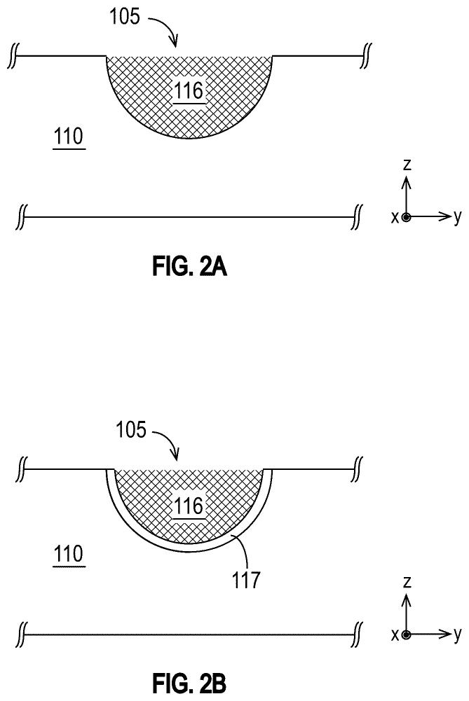

FIG. 2A is an illustration of a cross-section in a y-z plane of a portion of an example of a die 110 that includes at least one operative channel 105 in accordance with some embodiments. In the illustrated example, the reactive material 116 is in contact with the material of the die 110.

Although it may be safe for the reactive material 116 to be in contact with some materials used in the microelectronic circuit package 100, other materials that could be used in the microelectronic circuit package 100 may be reactive with the reactive material 116. For example, aluminum, copper (at high temperatures), polyimide, photoresist, and certain low-K dielectrics can react with Nak and RbCs. Silicon at high temperatures or with specific impurities could also have some interaction with NaK and/or RbCs. Therefore, in some embodiments, the interior surface of each of the at least one operative channel 105 is lined with a non-reactive material.

FIG. 2B is an illustration of a cross-section in a y-z plane of a portion of an example of a die 110 in which protective material 117 lines the interior of an operative channel 105 in accordance with some embodiments. As explained above, the protective material 117 is a material that does not react (i.e., is non-reactive) with the reactive material 116. For example, if the reactive material 116 comprises NaK or RbCs, to prevent a reaction between the reactive material 116 and the material in which the at least one operative channel 105 is created (whether in a die 110, in the encapsulant 166, or elsewhere in the microelectronic circuit package 100), the protective material 117 can comprise one or more of stainless steel, nickel, a nickel alloy, tantalum, titanium, molybdenum, glass, graphite, alumina, silicon carbide, an inert plastic (e.g., polytetrafluoroethylene (PTFE), polyetheretherketone (PEEK), etc.), encapsulant 166 material, or similar.

In some embodiments, at least one operative channel 105 in the microelectronic circuit package 100 is an integral part of the signal and/or power wiring for the microelectronic circuit package 100. In other words, in some embodiments, at least one operative channel 105 carries power and/or signals for the microelectronic circuit package 100 (e.g., to and/or from the die 110, within the die 110, etc.).

Although FIG. 1B illustrates a microelectronic circuit package 100 with a single operative channel 105, the microelectronic circuit package 100 can have any number of operative channels 105, as shown and described in the context of other examples herein.

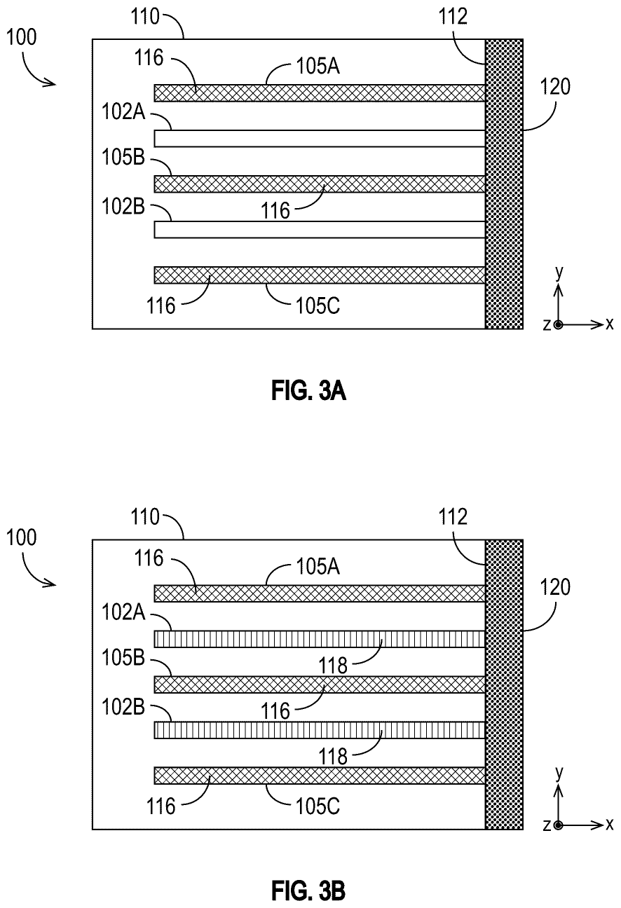

In some embodiments, the microelectronic circuit package 100 comprises at least one operative channel 105 and at least one decoy channel. The at least one decoy channel can be provided to obfuscate the functionality of the at least one operative channel 105 and/or to provide an additional trap for reverse engineers. FIG. 3A illustrates an example of a microelectronic circuit package 100 that includes a die 110 that has three operative channels 105 and two decoy channels 102 in accordance with some embodiments. Specifically, the die 110 shown in FIG. 3A includes the operative channel 105A, the operative channel 105B, the operative channel 105C, the decoy channel 102A, and the decoy channel 102B. The decoy channel 102A is situated between the operative channel 105A and the operative channel 105B, and the decoy channel 102B is situated between the operative channel 105B and the operative channel 105C. It is to be appreciated that the microelectronic circuit package 100 shown in FIG. 3A is merely an example. An implementation of a microelectronic circuit package 100 that includes at least one operative channel 105 and at least one decoy channel 102 can include any number of operative channels 105 and any number of decoy channels 102. To deter reverse engineering attempts, it may be desirable to have at least a few operative channels 105 and at least a few decoy channels 102, but this is not a requirement. There is also no requirement for the at least one operative channel 105 and at least one decoy channel 102 to be in any particular arrangement relative to each other. For example, there is no requirement for an alternating pattern as shown in FIG. 3A.

In some embodiments, the structures (e.g., size and shape) of the at least one operative channel 105 and at least one decoy channel 102 are substantially the same. In other words, in some embodiments, the at least one operative channel 105 and at least one decoy channel 102 are structurally indistinguishable but have different contents. Use of substantially the same size and shape for the at least one decoy channel 102 as for the at least one operative channel 105 can increase the difficulty of distinguishing between the at least one decoy channel 102 and the at least one operative channel 105, as explained further below.

In the example of FIG. 3A, each of the operative channel 105A, operative channel 105B, and operative channel 105C extends to an edge surface 112 that is covered by a seal 120. Each of the operative channel 105A, operative channel 105B, and operative channel 105C is filled with a reactive material 116. The decoy channel 102A and decoy channel 102B also extend to the edge surface 112, and their ends are also covered by the seal 120. Unlike the at least one operative channel 105, however, the decoy channels 102 are not filled with the reactive material 116. In the example of FIG. 3A, each of the at least one decoy channel 102 is empty (unfilled).

As in FIG. 1B, the seal 120 covers the edge surface 112 of the die 110 and prevents the reactive material 116 from being exposed to oxygen and/or water (e.g., humidity). The seal 120 also covers the ends of the unfilled decoy channel 102A and the unfilled decoy channel 102B. The discussion of the seal 120 in the context of FIG. 1B also applies to FIG. 3A and is not repeated.

In some embodiments, one or more of the decoy channels 102 are filled by a material that is different from the reactive material 116. FIG. 3B is an illustration of an example die 110 in which the at least one decoy channel 102 is filled by a second material 118 in accordance with some embodiments. In some embodiments, the second material 118 is different from the reactive material 116 and does not react violently (e.g., with oxygen and/or water) as the reactive material 116 does. In some embodiments, the second material 118 is different from the reactive material 116, and, like the reactive material 116, reacts violently (e.g., when exposed to oxygen and/or water).

The second material 118 can be any suitable conductive or non-conductive material. For example, the second material 118 can be a conductive material. In some embodiments, at least one decoy channel 102 is included in the wiring (e.g., for signal transfer, power, etc.) of the microelectronic circuit package 100. Any suitable conductive material can be used as the second material 118. For example, when the second material 118 is conductive, the second material 118 can be an ionic liquid, a liquid metal (e.g., mercury, gallium, eutectic gallium-indium, etc.), an electrolyte (i.e., a solution containing dissolved salts, acids, or bases that ionize and conduct electricity), a conductive polymer (e.g., polyaniline (PANI), polypyrrole (PPy), poly(3,4-ethylenedioxythiophene) (PEDOT), etc.), a liquid crystal polymer (e.g., nematic and smectic liquid crystals with added conductive dopants), a nanoparticle suspension (e.g., a suspension of silver nanoparticles, carbon nanotubes, or graphene in a liquid medium), etc.

Alternatively, the second material 118 can be non-conductive. As an example, the second material 118 could be trimethyl aluminum, which can be made in large quantities and is inexpensive. As explained further below, filling the at least one decoy channel 102 can provide additional protection against tampering attempts.

It is to be appreciated that the microelectronic circuit package 100 can include elements or components in addition to those illustrated in FIGS. 1A, 1B, 3A, and 3B. In addition, although this document sometimes refers to the microelectronic circuit package 100 as if it has only a single die 110, as explained previously, the microelectronic circuit package 100 can include more than one die 110. The scope of the disclosures herein is not limited to the examples provided.

As explained above, each of the at least one operative channel 105 is physically narrow (e.g., it has a maximum width/diameter/height of less than about 100 microns). As will be appreciated, because the at least one operative channel 105 is narrow, filling the at least one operative channel 105 with the reactive material 116 could be challenging. Similarly, in some embodiments that include at least one decoy channel 102, each of the at least one decoy channel 102 is physically narrow (e.g., like the at least one operative channel 105) and has dimensions similar to those of the at least one operative channel 105. As explained above, filling such small channels with a second material 118 can be challenging.

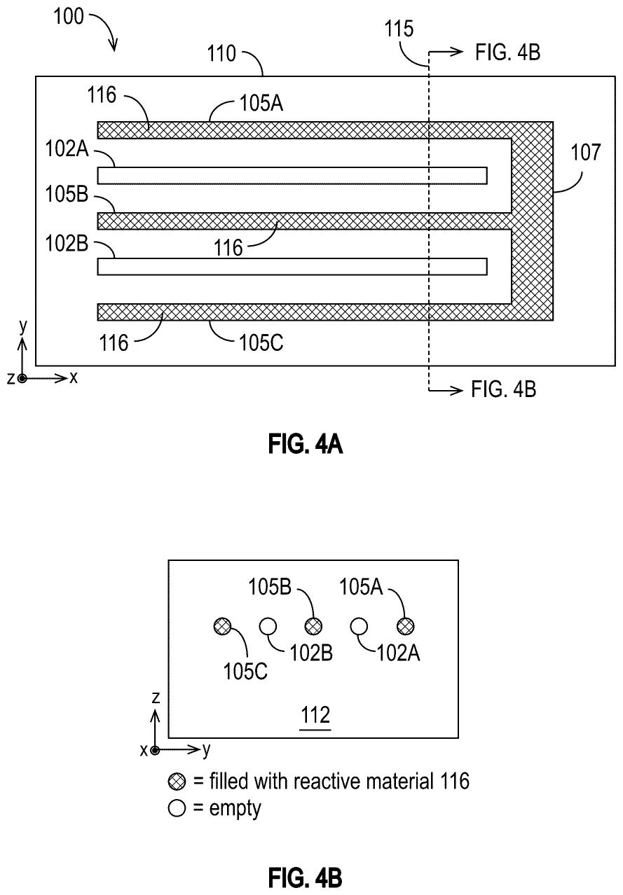

FIG. 4A illustrates an example technique for creating the example of the microelectronic circuit package 100 shown in FIG. 3A in accordance with some embodiments. (It will be appreciated that a similar configuration can be used to fill the at least one operative channel 105 shown in FIG. 1B.) FIG. 4A represents the work-in-progress microelectronic circuit package 100 at some point during the manufacturing process. In the illustrated example, the decoy channel 102A and decoy channel 102B are empty.

To fill the operative channel 105A, operative channel 105B, and operative channel 105C with the reactive material 116, the example shown in FIG. 4A includes a sprue region 107 in the work-in-progress microelectronic circuit package 100. As will be appreciated, a sprue is a component used in certain manufacturing processes, such as casting and molding, to direct liquid or molten material into a mold. Each of the operative channel 105A, operative channel 105B, and operative channel 105C extends in the x-direction beyond a shear line 115 to join with the sprue region 107. In other words, the operative channel 105A, operative channel 105B, and operative channel 105C are connected to the sprue region 107. In contrast, the decoy channel 102A and decoy channel 102B are not connected to the sprue region 107. The sprue region 107 provides a way for the operative channel 105A, operative channel 105B, and operative channel 105C to be filled during the manufacturing process.

Specifically, the reactive material 116 can be poured or injected into the sprue region 107, which then directs the reactive material 116 into the at least one operative channel 105 (namely, operative channel 105A, operative channel 105B, and operative channel 105C in FIG. 4A).

After the sprue region 107 has directed the reactive material 116 into the at least one operative channel 105, the sprue region 107 can be removed from the die 110 (e.g., by cutting or breaking) at the shear line 115, thereby leaving an exposed wafer surface (i.e., the edge surface 112). The seal 120 can then be added to the die 110 to form a configuration such as the one shown in FIG. 3A. Alternatively, the sprue region 107 can be left intact as part of the microelectronic circuit package 100, in which case the seal 120 can be applied over and/or around the sprue region 107.

FIG. 4B is cross-section view of the microelectronic circuit package 100 example shown in FIG. 4A at the shear line 115 in accordance with some embodiments. In other words, FIG. 4B shows the edge surface 112 of the die 110 of FIG. 3A before the seal 120 has been added. It will be appreciated that FIG. 4B is not to scale. In an implementation of a microelectronic circuit package 100, the ends of the at least one operative channel 105 and the at least one decoy channel 102 would be difficult to see at the edge surface 112 of the die 110, even under magnification, and the difference between the at least one operative channel 105 and the at least one decoy channel 102 (full versus empty) would be hard to detect. The difficulty of distinguishing between the at least one operative channel 105 and the at least one decoy channel 102 is even greater in embodiments in which the at least one decoy channel 102 are filled with second material 118.

As explained above, the at least one operative channel 105 and, if present, the at least one decoy channel 102 are physically narrow. In general, the at least one operative channel 105 and, if present, the at least one decoy channel 102, can have any suitable size and shape. FIGS. 2A and 2B illustrate the at least one decoy channel 102 and at least one operative channel 105 having half-cylindrical cross sections, and FIG. 4B illustrates the at least one decoy channel 102 and at least one operative channel 105 as cylindrical, but it is to be appreciated that, in general, the at least one operative channel 105 and, if present, the at least one decoy channel 102, can have any size and shape. In some embodiments, the at least one operative channel 105 (and, if present, the at least one decoy channel 102) have a maximum width 104 that is less than 100 microns. If the at least one decoy channel 102 is included, whether empty or filled, it is desirable for the at least one decoy channel 102 to have the same size and shape as the at least one operative channel 105 to increase the difficulty of distinguishing between the at least one operative channel 105 and the at least one decoy channel 102.

As explained above, the reactive material 116 in some or all of the at least one operative channel 105 can be conductive, and the at least one operative channel 105 can form a part of the power and/or signal transfer circuitry for the microelectronic circuit package 100. In some embodiments, at least one operative channel 105 is coupled to power supplies of the microelectronic circuit package 100 such that if the reactive material 116 is removed, one or more power paths are open circuited (cut), and the microelectronic circuit package 100 cannot operate. In some embodiments, at least one decoy channel 102 is configured to cause a short circuit in the power circuitry if a reverse engineer successfully fills the at least one decoy channel 102 with the reactive material 116 or with another conductive material.

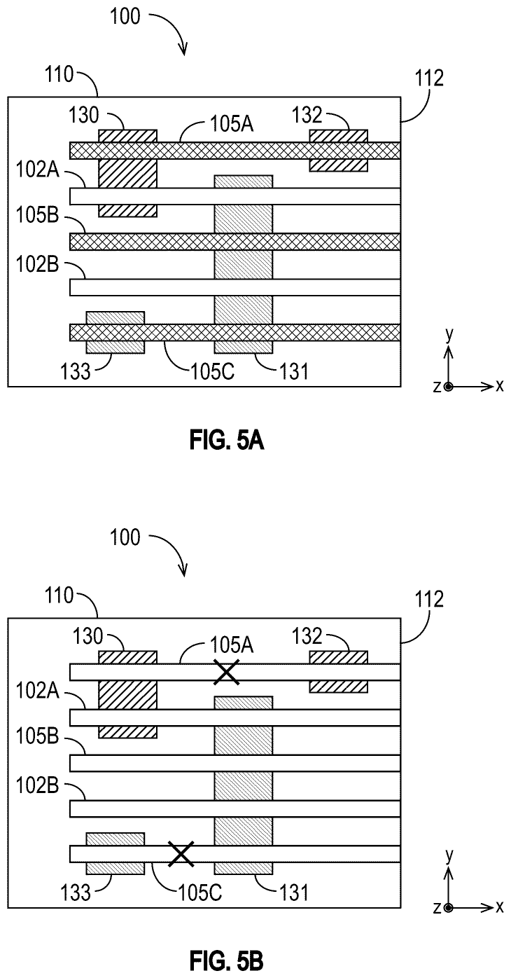

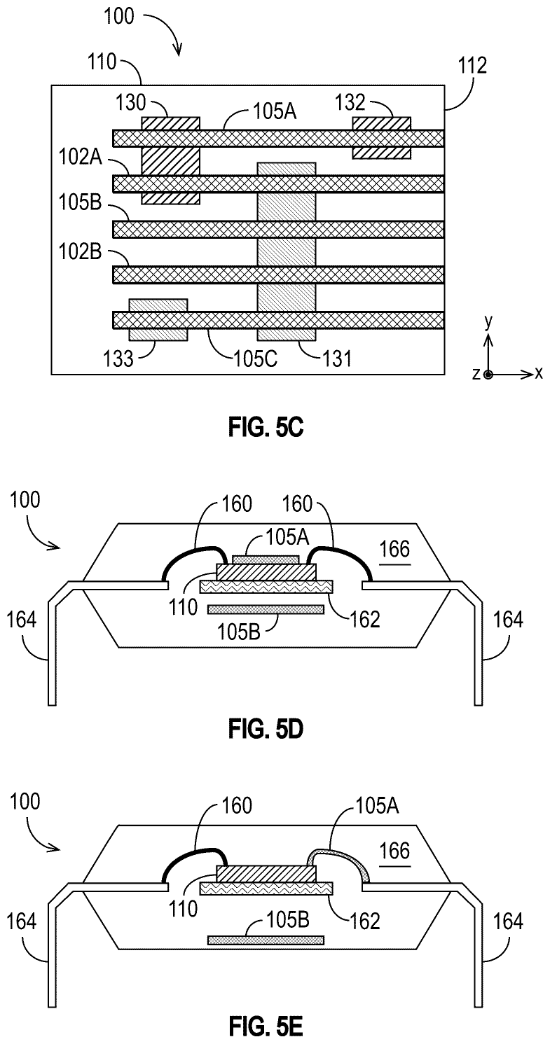

FIG. 5A is a top view of a portion of the microelectronic circuit package 100 in accordance with some embodiments. The microelectronic circuit package 100 shown in FIG. 5A includes the operative channel 105A, operative channel 105B, operative channel 105C, decoy channel 102A, and decoy channel 102B described above in the context of FIG. 3B. Those descriptions apply to the example of FIG. 5A and are not repeated. In addition, the microelectronic circuit package 100 of FIG. 5A includes a positive power supply input 130 (e.g., V_{CC} or V_{DD}), a negative power supply input 131 (e.g., V_{SS}, V_{EE}, GND), an on-chip positive power supply 132 (e.g., a positive power rail, positive power island, positive power domain, etc.), and an on-chip negative power supply 133 (e.g., a negative power rail, negative power island, negative power domain, etc.).

The view shown in FIG. 5A is conceptual and shows components of the die 110 at different positions along the z-axis (e.g., in different layers of the microelectronic circuit package 100). For example, the operative channel 105A, operative channel 105B, operative channel 105C, decoy channel 102A, and decoy channel 102B in FIG. 5A are at higher positions along the z-axis than the positive power supply input 130, negative power supply input 131, on-chip positive power supply 132, and on-chip negative power supply 133. (It is to be appreciated that the at least one operative channel 105 and/or the at least one decoy channel 102 could alternatively be below the other components shown in FIG. 5A.) Components at different layers of the die 110 can be coupled to each other using any suitable approach. For example, the operative channel 105A can be connected to the positive power supply input 130 and the on-chip positive power supply 132 by vias.

In the example of FIG. 5A, the positive power supply input 130 is coupled to the operative channel 105A and the decoy channel 102A (e.g., by vias, not illustrated). The negative power supply input 131 is coupled (e.g., by vias) to the decoy channel 102A, the operative channel 105B, the decoy channel 102B, and the operative channel 105C. The on-chip positive power supply 132 is coupled to the operative channel 105A (e.g., by vias), and the on-chip negative power supply 133 is coupled to the operative channel 105C. In operation, the operative channel 105A couples the on-chip positive power supply 132 to the positive power supply input 130, and the operative channel 105C couples the negative power supply input 131 to the on-chip negative power supply 133.

FIG. 5B shows how removing the reactive material 116 from the at least one operative channel 105 can adversely affect the power connections of the microelectronic circuit package 100 in accordance with some embodiments. FIG. 5B shows the operative channel 105A, operative channel 105B, and operative channel 105C after the reactive material 116 has been removed (e.g., by a reverse engineer removing the seal 120 and removing the reactive material 116 without destroying the die 110). As shown in FIG. 5B, if the reactive material 116 in the operative channel 105A is removed, the connection between the positive power supply input 130 and the on-chip positive power supply 132 is severed (open-circuited), and the on-chip positive power supply 132 cannot provide power to the components of the die 110 and/or the microelectronic circuit package 100. Similarly, if the reactive material 116 in the operative channel 105C is removed, the connection between the negative power supply input 131 and the on-chip negative power supply 133 is severed.

Thus, a reverse engineer who successfully removed the reactive material 116 without destroying the die 110 altogether would find that doing so caused the microelectronic circuit package 100 to stop working. He might realize that the reactive material 116 has a role in the functioning of the microelectronic circuit package 100. As a result, he might attempt to refill the at least one operative channel 105 with reactive material 116 (or another conductor) to try to make the microelectronic circuit package 100 work again. As explained above, in some embodiments, at least one decoy channel 102 is provided in addition to the at least one operative channel 105, and a reverse engineer who removes the seal 120 may have difficulty distinguishing between the at least one operative channel 105 and the at least one decoy channel 102. Even if he realizes that the microelectronic circuit package 100 includes at least one decoy channel 102, he will not be able to tell easily which of the channels are at least one operative channel 105 and which are at least one decoy channel 102. As explained above, the at least one operative channel 105 is intentionally designed to be difficult to fill without the sprue region 107, and therefore a reverse engineer might have not have a suitable technique to fill any of the at least one operative channel 105 or at least one decoy channel 102 at all, much less a subset of them. Therefore, he may fill all of the at least one operative channel 105 and all of the at least one decoy channel 102 with some kind of conductor (e.g., the reactive material 116 or another conductor).

FIG. 5C is an illustration of how filling the at least one decoy channel 102 with reactive material 116 (or another conductor) can cause the microelectronic circuit package 100 to fail in accordance with some embodiments. As shown in FIG. 5C, if reactive material 116 (or any conductive material) is added to the decoy channel 102A, the result is a short circuit between the positive power supply input 130 and the negative power supply input 131. The circuits of the microelectronic circuit package 100 can be designed so that these short circuits render the microelectronic circuit package 100 inoperable.

It is to be appreciated that the at least one decoy channel 102 can be used similarly to the at least one operative channel 105 in providing power and/or signaling for the microelectronic circuit package 100. For example, in embodiments in which the second material 118 is conductive, the at least one decoy channel 102 can be used to cause short or open circuits in the power and/or signaling of the electronics in the microelectronic circuit package 100 similarly to the at least one operative channel 105 (e.g., as described in the context of FIGS. 5A, 5B, and 5C).

FIGS. 5A, 5B, and 5C provide a specific example of how the at least one operative channel 105 can be included in the power circuitry of the microelectronic circuit package 100, and a specific example of how the at least one decoy channel 102 can be configured to cause the microelectronic circuit package 100 to malfunction and/or be damaged due to reverse engineering attempts. It will be appreciated that there are many other ways to configure the at least one operative channel 105 and the at least one decoy channel 102 to frustrate reverse engineering attempts (e.g., to short-circuit signal pathways, to apply a damaging voltage level to a component, etc.). In addition, as explained above, the number of operative channels 105 and (if included) decoy channels 102 can be different than shown in the examples herein.

FIGS. 1B, 2A, 2B, 3A, 3B, 4A, 4B, 5A, 5B, and 5C are examples illustrating the at least one operative channel 105 (and, if present, the at least one decoy channel 102) implemented in a die 110 of the microelectronic circuit package 100. It is to be appreciated that, in addition or alternatively, the at least one operative channel 105 (and, if present, the at least one decoy channel 102) can be situated elsewhere in the microelectronic circuit package 100. For example, at least one operative channel 105 can be included in the encapsulant 166. As another example, the at least one operative channel 105 can be or be part of the bonding wires 160 shown in FIG. 1A. An implementation can include at least one operative channel 105 in a die 110 as well as elsewhere in the microelectronic circuit package 100 (e.g., on the die 110, under the die 110, over the die 110, in the encapsulant 166, etc.). Likewise, if at least one decoy channel 102 is used, an implementation can include at least one decoy channel 102 in a die 110 and/or elsewhere in the microelectronic circuit package 100.

FIG. 5D is an example of a microelectronic circuit package 100 in which at least one operative channel 105 is situated in the encapsulant 166 in accordance with some embodiments. In the illustrated example, an operative channel 105A is situated in the encapsulant 166 adjacent to the die 110, and an operative channel 105B is situated in the encapsulant 166 below the substrate 162. It is to be appreciated that there can be more or fewer operative channels 105 included in the microelectronic circuit package 100.

FIG. 5E is an example of a microelectronic circuit package 100 in which an operative channel 105 replaces one of the bonding wires 160 in accordance with some embodiments. In the example, the bonding wire shown to the right of the die 110 in FIG. 5D has been replaced in FIG. 5E by an operative channel 105A. An operative channel 105B is also situated in the encapsulant 166, close to the bottom edge of the microelectronic circuit package 100. Thus, as shown by FIGS. 5D and 5E, at least one operative channel 105 can be situated virtually anywhere in the microelectronic circuit package 100. Therefore, the at least one operative channel 105 can be part of the die 110 and/or included elsewhere in the microelectronic circuit package 100.

Thus, in some embodiments, the microelectronic circuit package 100 includes (e.g., in a die 110, on a die 110, in reactive material 116, etc.) at least one operative channel 105, each of which contains reactive material 116, and a seal 120 covering at least a portion of the at least one operative channel 105 (e.g., to prevent the reactive material 116 from being exposed). The seal 120 is non-reactive with the reactive material 116. In some embodiments, the at least one operative channel 105 is narrow so as to frustrate refilling attempts. In some embodiments, the at least one operative channel 105 has a maximum width of less than about 100 microns.

In addition to the physical protection techniques described above, the at least one operative channel 105 and, if present, the at least one decoy channel 102 can be used by the microelectronic circuit package 100 to provide software-based protection. For example, in some embodiments, the reactive material 116 at least one operative channel 105 can be used by the microelectronic circuit package 100 in a validation process (e.g., a self-test routine) that can be performed whenever the microelectronic circuit package 100 is powered on. For example, the microelectronic circuit package 100 can include hardware that detects changes to or in the reactive material 116 in at least one operative channel 105. For example, the microelectronic circuit package 100 can include circuitry to detect the resistance or capacitance (e.g., a dielectric property) of at least one operative channel 105 and/or at least one decoy channel 102 whenever the microelectronic circuit package 100 is powered on. If the contents of any monitored operative channel 105 or any monitored decoy channel 102 have been modified (e.g., reactive material 116 has been removed from at least one operative channel 105, second material 118 has been removed from at least one decoy channel 102, at least one decoy channel 102 that is supposed to be empty has been filled, etc.), the resistance (or capacitance, or dielectric property) will likely change. Upon detecting that change, the start-up procedure for microelectronic circuit package 100 can be aborted, and/or other protective measures can be taken (e.g., to prevent execution of code, prevent booting, erase or overwrite sensitive data, disable itself, disable communication interfaces, blow hardware fuses to permanently disable specific functionalities or the entire microelectronic circuit package 100, etc.).

As another example, the reactive material 116 can have a random characteristic (e.g., irregular or random features) that is measurable or detectable, and changes to the characteristic can be detected and used to infer that tampering has occurred. For example, random features, such as bubbles, can be introduced into the reactive material 116 in the at least one operative channel 105. As a specific example, in the case that NaK or RbCs is used as the reactive material 116, a stable suspension of bubbles, in random positions, can be created during manufacturing. Because NaK and RbCs react violently with both oxygen and water, the bubbles can be created using an inert gas such as argon or nitrogen to mitigate reactivity issues. Very small bubbles (microbubbles or nanobubbles) can be created to help achieve a more stable suspension. Techniques such as, for example, ultrasonic agitation or specialized injectors can be used to create and maintain these small bubbles within NaK or RbCs. Another technique is to encapsulate gas within stable, inert shells (e.g., using metal or ceramic coatings) before introducing them into Nak or RbCs to prevent direct contact between the gas and the alloy, which reduces reactivity and increases stability.

In some embodiments, the reactive material 116 has random features, and the presence and/or locations of those random features can be detected (e.g., using sensors) when the microelectronic circuit package 100 powers on or at any time during operation of the microelectronic circuit package 100 (e.g., periodically, at random points in time, etc.). In some embodiments, the presence of at least one random feature in the reactive material 116 or a configuration of at least one random feature in the reactive material 116 is sensed. If the contents of any monitored operative channel 105 have been modified, the probability that the random features are present and/or remain in the same place as when the microelectronic circuit package 100 was manufactured is vanishingly small. Upon detecting that the configuration of the random feature (e.g., bubbles, etc.) has changed, the microelectronic circuit package 100 can abort its start-up procedure and/or take other protective measures (e.g., prevent execution of code, prevent booting, erase or overwrite sensitive data, disable itself, disable communication interfaces, blow hardware fuses to permanently disable specific functionalities or the entire microelectronic circuit package 100, etc.).

As another example of a random, measurable/detectable characteristic of the reactive material 116, particles that are non-reactive with the reactive material 116 can be mixed into the reactive material 116. As a result, the reactive material 116 has particles in random locations, and the presence, locations, clustering, and/or some other aspect of these random features can be detected. For example, if the reactive material 116 is NaK or RbCs, non-reactive metal particles (e.g., copper, gold, silver, platinum, iron, nickel, etc.) can be mixed into the reactive material 116. As another example, non-metallic particles (e.g., carbon nanotubes, graphene, boron nitride, fullerenes, etc.) can be mixed into the reactive material 116 (e.g., NaK, RbCs). As other examples, oxide particles (e.g., alumina, silica, titanium dioxide, etc.), ceramic particles (e.g., silicon carbide, zirconia, etc.), or nanoscale particles (nanoparticles) can be mixed into the reactive material 116. Because the distribution of particles in the reactive material 116 is intended to be random, it is not necessary to prevent agglomeration of particles (e.g., magnetic particles).

In some embodiments, the reactive material 116 has particles in it as random features, and the presence and/or locations of those particles can be detected (e.g., using sensors) when the microelectronic circuit package 100 powers on and/or at any time afterward (e.g., periodically, at random times, etc.). If the contents of any monitored operative channel 105 have been modified, the probability that the particles are present and remain in the same configuration as when the microelectronic circuit package 100 was manufactured is vanishingly small. Upon detecting that the configuration of particles has changed, the microelectronic circuit package 100 can abort its start-up procedure and/or take other protective measures (e.g., prevent execution of code, prevent booting, erase or overwrite sensitive data, disable itself, disable communication interfaces, blow hardware fuses to permanently disable specific functionalities or the entire microelectronic circuit package 100, etc.).

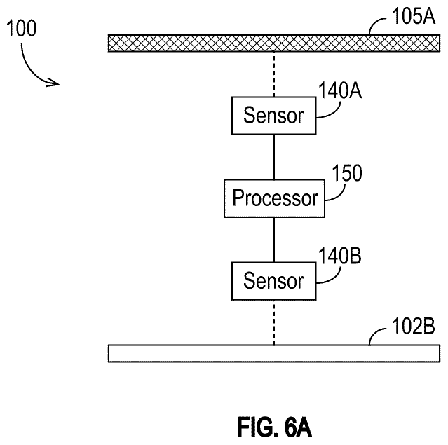

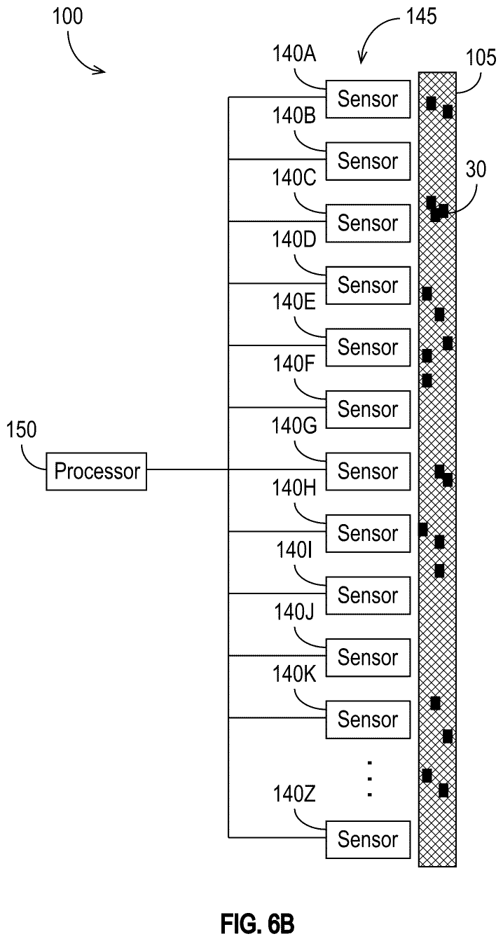

FIG. 6A is an example of components that can be used to detect changes in one or more of the at least one operative channel 105 and/or in one or more of the at least one decoy channel 102 in accordance with some embodiments. One or more operative channels 105 and/or one or more decoy channels 102 can be monitored by one or more sensors 140. In the example shown in FIG. 6A, the operative channel 105A is monitored by a sensor 140A, and the decoy channel 102B is monitored by a sensor 140B. There may be additional operative channels 105 and/or decoy channels 102 in the microelectronic circuit package 100, and those operative channels 105 and/or decoy channels 102 can be monitored by respective sensors 140, or they can be unmonitored.

The sensor 140A and the sensor 140B shown in the example of FIG. 6A are configured to monitor a characteristic of, respectively, the reactive material 116 in the operative channel 105A and contents of the decoy channel 102B to detect changes that indicate tampering. For example, as explained above, the sensor 140A can monitor the resistance (or another property, such as capacitance) of the reactive material 116, and the sensor 140B can monitor the resistance (or another property, such as capacitance) of the decoy channel 102B. FIG. 6A illustrates the decoy channel 102B as being empty. If the decoy channel 102B is filled, the detected resistance (or other property) will likely change, which can be interpreted as indicating tampering. In embodiments in which the decoy channel 102B is filled by a second material 118 that is non-conductive, the sensor 140B can comprise capacitive electrodes to detect the presence/absence and/or changes to of the second material 118.

The sensor 140A and the sensor 140B are communicatively coupled to a processor 150. The processor 150 is configured to obtain from the sensor 140A and/or the sensor 140B an indication of the sensed characteristic (e.g., resistance, capacitance, dielectric property, presence, etc.) of the reactive material 116 in the operative channel 105A and/or the contents of (e.g., second material 118 or nothing) in the decoy channel 102B. The processor 150 is configured to determine, based at least in part on the indication of the sensed characteristic, that the characteristic of the reactive material 116 in at least one operative channel 105 has changed. In response to the determination that the characteristic of the reactive material 116 in at least one operative channel 105 (e.g., the operative channel 105A and/or the characteristic of the decoy channel 102B) has changed, the processor 150 can take an action. For example, as explained above, the processor 150 could abort a start-up procedure, prevent execution of code, prevent booting, erase or overwrite data (e.g., sensitive data), disable a function of the microelectronic circuit package 100, disable the microelectronic circuit package 100 altogether, disable a communication interface of the microelectronic circuit package 100, and/or blow a hardware fuse of the microelectronic circuit package 100.

In some embodiments, an array of sensors 140 is situated along at least one operative channel 105 and/or along at least one decoy channel 102 to sense the contents the at least one operative channel 105 and/or the contents of the at least one decoy channel 102 along its length. FIG. 6B is an example of a sensor array 145 situated along an operative channel 105 in accordance with some embodiments. It is to be appreciated that in embodiments in which at least one decoy channel 102 is filled by the second material 118, a similar configuration can be used to monitor its contents.

FIG. 6B shows a total of twelve sensors: the sensor 140A, the sensor 140B, the sensor 140C, the sensor 140D, the sensor 140E, the sensor 140F, the sensor 140G, the sensor 140H, the sensor 140I, the sensor 140J, the sensor 140K, and the sensor 140Z. Each sensor 140 of the sensor array 145 senses a respective portion of the operative channel 105. In the illustrated example, the operative channel 105 contains reactive material 116 that includes a detectable substance or material (e.g., bubbles, particles, etc.), as explained above.

Each sensor 140 of the sensor array 145 is coupled to a processor 150. The processor 150 can read the sensor array 145 and/or receive signals from the individual sensors 140 in the sensor array 145. Based on the read results and/or the signals received from the sensor array 145, the processor 150 can determine what, if anything, each respective sensor 140 detected.

To provide a specific example of how the configuration of FIG. 6B can operate, the detectable substance or material can be magnetic particles 30, and each respective sensor 140 in the sensor array 145 can be a magnetic sensor (e.g., a magneto-resistive (MR) sensor) that can detect or sense whether at least one magnetic particle 30 is present in the region of the operative channel 105 sensed by the respective sensor 140. If changes are detected (e.g., if more than some percentage or some number of sensors 140 of the sensor array 145 detect changes), as explained above, the processor 150 can abort a start-up procedure, prevent execution of code, prevent booting, erase or overwrite data (e.g., sensitive data), disable a function of the microelectronic circuit package 100, disable the microelectronic circuit package 100 altogether, disable a communication interface of the microelectronic circuit package 100, blow a hardware fuse of the microelectronic circuit package 100, and/or take any other action to hamper reverse engineering attempts.

An additional technique to frustrate reverse engineering attempts is to use a detectable or measurable characteristic of the reactive material 116 in at least one operative channel 105 and/or a detectable or measurable characteristic of second material 118 in at least one decoy channel 102 (if present) to derive a cryptographic key used to secure data stored and/or generated and/or executed by the microelectronic circuit package 100. For example, whenever the microelectronic circuit package 100 powers on, the configuration of FIG. 6B can be used to derive a cryptographic key that is used to encrypt and decrypt data stored on and/or generated by the microelectronic circuit package 100. Each respective sensor 140 in the sensor array 145 can sense a characteristic of the reactive material 116 in its respective portion of the operative channel 105. In some embodiments, the sensed characteristic is a resistance of the reactive material 116, a capacitance of the reactive material 116, a dielectric property of the reactive material 116, presence of at least one random feature in the reactive material 116, or a configuration of at least one random feature in the reactive material 116. The cryptographic key can be derived from the results obtained using the sensor array 145 each time the microelectronic circuit package 100 powers on and/or at any other time (e.g., periodically, at random times, etc.). Whenever data is stored, it is encrypted using the key as currently detected. Thus, data stored by the microelectronic circuit package 100 will be properly decrypted only if the key derived from the observations from sensor array 145 allow the correct cryptographic key to be derived. If the operative channel 105 has been tampered with (e.g., emptied or refilled), the derived key will be different, and all data stored on the microelectronic circuit package 100 using a different, prior key will be secure and un-decryptable.

The key can be derived using any sensed characteristic of at least one operative channel 105. In some embodiments, the sensed characteristic is a resistance of the reactive material 116, a capacitance of the reactive material 116, a dielectric property of the reactive material 116, presence of at least one random feature in the reactive material 116, or a configuration of at least one random feature in the reactive material 116. As a specific example, assuming the reactive material 116 contains randomly-distributed magnetic particles 30, the sensor array 145 may include magnetoresistive (MR) sensors. As will be appreciated by those having ordinary skill in the art, an MR sensor is a device that measures magnetic fields using the magnetoresistive effect, whereby the electrical resistance of a material changes in response to an applied magnetic field. This change can be due to various mechanisms such as the alignment of magnetic domains or spin-dependent scattering of electrons.

Referring to FIG. 6B, the signal/resistance of each respective sensor 140 of the sensor array 145 can be interpreted as a 1 or a 0 (e.g., a 1 could signify that the respective sensor 140 detected at least one magnetic particle 30, and a 0 could signify that the respective sensor 140 did not detect any magnetic particle(s) 30). Because the magnetic particles 30 are distributed randomly in the reactive material 116 during the manufacturing process, the pattern of 1s and 0s derived from the sensor array 145 will also be random (assuming the number of particles included in the reactive material 116 is not so large that each respective sensor 140 always detects at least one magnetic particle 30 or so small that each respective sensor 140 never detects any magnetic particles 30). The random pattern of 1s and 0s generated in this manner can be the cryptographic key for the microelectronic circuit package 100.

With reference to FIG. 6B, and assuming that the only sensors 140 in the sensor array 145 are the twelve illustrated sensors, the cryptographic key could be as shown in the table below:

Sensor

| 140A | 140B | 140C | 140D | 140E | 140F | 140G | 140H | 140I | 140J | 140K | 140Z |
|---|---|---|---|---|---|---|---|---|---|---|---|
| 1 | 0 | 1 | 1 | 1 | 0 | 1 | 1 | 0 | 0 | 1 | 0 |

This key could then be used by the processor 150 (or another component of the microelectronic circuit package 100) to encrypt and decrypt data stored on the microelectronic circuit package 100. As long as the pattern of 1s and 0s remains constant, the microelectronic circuit package 100 will be able to decrypt data it stores.

Thus, based on the detection results of the sensor array 145 at any time (e.g., at power on, at periodic intervals, etc.), the processor 150 can derive a cryptographic key for the microelectronic circuit package 100. If the configuration of the at least one operative channel 105 and/or at least one decoy channel 102 from which the cryptographic key is derived changes such that the positions of the magnetic particles 30 change, the correct cryptographic key is lost, and the data stored by the microelectronic circuit package 100 cannot be recovered.

It will be appreciated that security provided by encryption is, in part, proportional to the length of the cryptographic key. Accordingly, the number of sensors 140 in the sensor array 145 can be selected to provide a cryptographic key of a desired length (e.g., 128 bits, 256 bits, etc.). The letters used in FIG. 6B do not indicate that the sensor array 145 has any particular number of sensors 140. It will be appreciated that changes to the contents of the operative channel 105 (e.g., due to tampering attempts) will at least change, and potentially annihilate, the cryptographic key. As a result, data stored in the microelectronic circuit package 100 is secure because the tampering results in the loss of the key needed to decrypt the data.

Although FIG. 6B illustrates a sensor array 145 arranged along a single operative channel 105, the sensors 140 of the sensor array 145 can be distributed to monitor multiple of the at least one operative channel 105 and/or the at least one decoy channel 102.

It is to be appreciated that although the use of most or all of the techniques described herein (involving some or all of physical, obfuscation, and hardware/software approaches) can be advantageous to frustrate reverse engineering attempts, fewer than all of the techniques can be used. For example, as explained above, it is not a requirement that at least one decoy channel 102 be included in the microelectronic circuit package 100. In some embodiments, a microelectronic circuit package 100 includes only at least one operative channel 105, such that if the seal 120 is removed in the presence of oxygen or water, the reactive material 116 in the at least one operative channel 105 should react violently enough to disable the microelectronic circuit package 100. The inclusion of only a single operative channel 105 can effectively protect data stored by the microelectronic circuit package 100, especially if the cryptographic key techniques described above are also included.

Accordingly, some or all of the techniques described herein can be used to provide various and/or multiple layers of protection from reverse engineering. The inclusion of at least one operative channel 105 by itself provides defenses in multiple ways. First, if the reactive material 116 reacts with chemicals commonly used to decap chips (e.g., as Nak and RbCs do with nitric acid and sulfuric acid), the decapping itself could cause the reactive material 116 to damage the microelectronic circuit package 100 contents to the point that the microelectronic circuit package 100 no longer operates and/or portions/all of the microelectronic circuit package 100 are destroyed.

Second, assuming the reactive material 116 is reactive with oxygen and/or water (e.g., the reactive material 116 comprises or is NaK, RbCs, or a similar material), even if decapping is successful, removal of the seal 120 in a standard air environment or while the microelectronic circuit package 100 is submerged in water would expose the reactive material 116 to oxygen and/or water and cause the reactive material 116 to react violently. This reaction could also be sufficient to cause substantial enough damage to the microelectronic circuit package 100 that the electronics are no longer operational and/or are partially or fully destroyed.

Third, once an attacker has realized that the microelectronic circuit package 100 includes the reactive material 116, he might attempt to prevent the reaction. For example, if he learns that decapping in a standard air environment or water causes the reactive material 116 to damage or destroy the microelectronic circuit package 100, he might decap the microelectronic circuit package 100 in a low-oxygen or inert environment (e.g., argon, nitrogen, etc.). For example, if the reactive material 116 is NaK or RbCs, the seal 120 could be removed in a low-oxygen environment, and the reactive material 116 could be flushed from the at least one operative channel 105. But in embodiments in which the at least one operative channel 105 integral to the operation of the microelectronic circuit package 100 (e.g., in the signal and/or power circuitry as described above in the discussion of FIGS. 5A-5E), removal of the reactive material 116 from the at least one operative channel 105 can cause the microelectronic circuit package 100 to be nonfunctional.

Fourth, if the reverse engineer realizes after removing the reactive material 116 that the reactive material 116 must somehow be involved in power and/or signal transfer for the microelectronic circuit package 100 (e.g., as discussed above in the context of FIGS. 5A and 5B), he will need to find a way to refill the at least one operative channel 105 with the reactive material 116 or another conductor. As explained above, the at least one operative channel 105 is physically small (narrow, e.g., no more than about 100 microns at its maximum width), and introducing fluid into channels of this size can be challenging due to the effects of surface tension and the need for precise control over flow rates. As explained above in the discussion of FIG. 4A, the sprue region 107 used to fill the at least one operative channel 105 can be removed during the manufacturing process to make refilling much more difficult for a reverse engineer. Thus, in some embodiments, the reverse engineer will not be able to use the sprue region 107. As a result, it would likely be challenging or impossible to refill the at least one operative channel 105.

In addition, the at least one operative channel 105 can be designed to discourage refilling. For example, certain physical channel characteristics promote the filling of a fluid channel (e.g., surfaces that are compatible with the fluid to promote wetting and reduce resistance to flow, a channel geometry (e.g., curvature, tapering, etc.) that facilitates smooth fluid entry and minimizes air trapping, etc.). The at least one operative channel 105 can be designed to lack these physical characteristics to hinder refill attempts. Conversely, if present, the at least one decoy channel 102 can be designed to include these physical characteristics to promote filling of the at least one decoy channel 102 and the resultant damage to or destruction of the microelectronic circuit package 100 due to reverse engineering attempts (e.g., as described in the context of FIGS. 5A-5E).

Even if the reverse engineer finds a way to refill the at least one operative channel 105 (e.g., by using a vacuum chamber, evacuating the air, and then introducing the reactive material 116), in embodiments in which the microelectronic circuit package 100 also includes at least one decoy channel 102, he will likely not be able to refill the at least one operative channel 105 without also filling the at least one decoy channel 102. Thus, the reverse engineer might simply refill all of the at least one operative channel 105 and all of the at least one decoy channel 102. In this case, as explained above in the discussion of FIG. 5C, depending on how the at least one decoy channel 102 is coupled to other components of the microelectronic circuit package 100, the filling of the at least one decoy channel 102 could cause irreparable damage to the microelectronic circuit package 100 (e.g., a short between the positive power supply input 130 and the negative power supply input 131, as shown in FIG. 5C). Even if the reverse engineer can find a way to fill individual ones of the at least one operative channel 105 and at least one decoy channel 102, in some embodiments, he will not be able to distinguish easily between the at least one operative channel 105 and the at least one decoy channel 102, because in some embodiments they appear to be identical (e.g., at the edge surface 112; see FIG. 4B).

Moreover, as explained above in the discussion of FIGS. 6A and 6B, in some embodiments, the contents of the at least one operative channel 105 (and/or at least one decoy channel 102) can be monitored. Upon detecting a change, the start-up procedure for microelectronic circuit package 100 can be aborted, and/or other protective measures can be taken (e.g., to prevent execution of code, prevent booting, erase or overwrite sensitive data, disable itself, disable communication interfaces, blow hardware fuses to permanently disable specific functionalities or the entire microelectronic circuit package 100, etc.).

In addition, as explained above in the context of FIG. 6B, in some embodiments, the contents of the at least one operative channel 105 (and/or at least one decoy channel 102) are used to derive a cryptographic key (e.g., each time the microelectronic circuit package 100 is powered on or at any time afterward), and data stored on the microelectronic circuit package 100 is encrypted and decrypted using this key. Accordingly, even if the reverse engineer manages to refill the at least one operative channel 105 with the reactive material 116, and even if he manages to do so while avoiding the short and open circuits and other problems described above, the characteristic used to derive the cryptographic key will almost certainly be different and/or missing relative to the original configuration of the reactive material 116 before it was removed (and/or the original configuration of the second material 118 before it was removed). Even if the reverse engineer knows what characteristic(s) of the reactive material 116 (and/or second material 118) are used to derive the cryptographic key, because those characteristics (e.g., the presence and/or distribution of bubbles, particles, etc.) is random, the probability of being to recreate the correct cryptographic key from one or more refilled operative channels 105 (and/or one or more refilled decoy channels 102) is so small as to be effectively zero. Thus, the data stored by the microelectronic circuit package 100 is secure and almost certainly cannot be decrypted if the at least one operative channel 105 and/or at least one decoy channel 102 is modified by tampering.

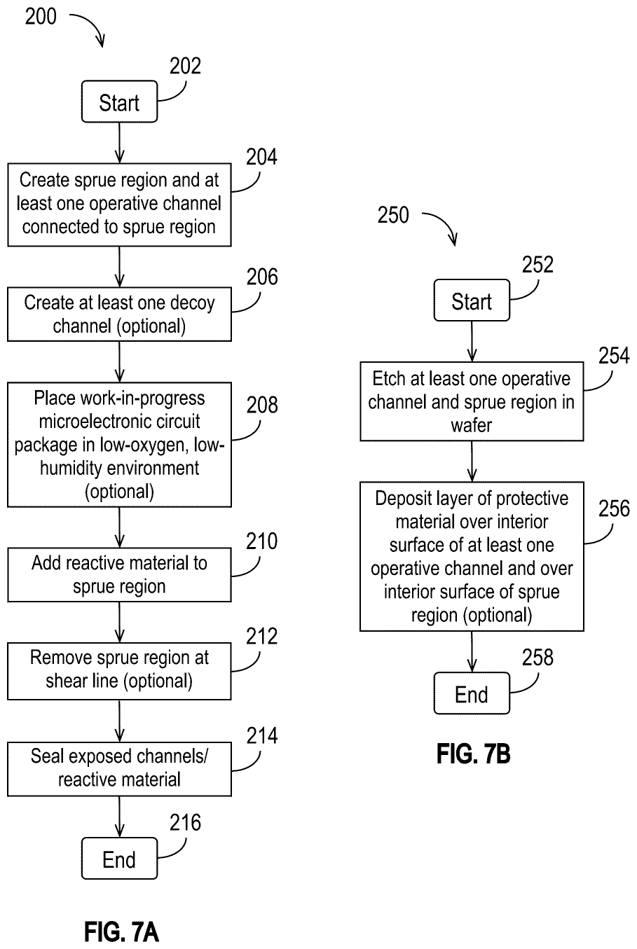

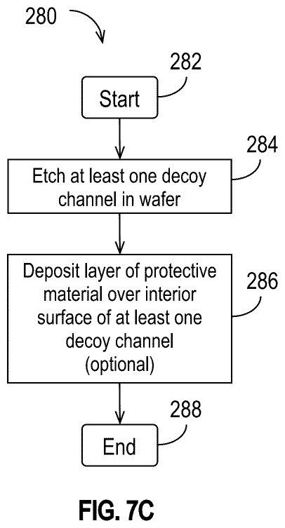

FIG. 7A is a flow diagram illustrating a method 200 of manufacturing a microelectronic circuit package 100 that includes at least one operative channel 105 in accordance with some embodiments. At block 202, the method begins. At block 204, a sprue region 107 and at least one operative channel 105 connected to the spruce region 107 are created in a work-in-progress microelectronic circuit package 100. As explained above, the at least one operative channel 105 may have a maximum width 104 that is less than about 100 microns. In addition, or alternatively, the at least one operative channel 105 can have a length 106 that is at least ten times the maximum width 104. In some embodiments, the sprue region 107 and the at least one operative channel 105 are created in a wafer (e.g., to create the die 110). For example, the sprue region 107 and at least one operative channel 105 can be created in the wafer using photolithography. In some embodiments, the sprue region 107 and the at least one operative channel 105 are created elsewhere in the work-in-progress microelectronic circuit package 100 (e.g., in the encapsulant 166, as part of the wiring, etc.) as described above.

At block 206, optionally, at least one decoy channel 102 is created in the work-in-progress microelectronic circuit package 100. In some embodiments, the at least one decoy channel 102 is interspersed among the at least one operative channel 105 (e.g., as shown in FIGS. 3A, 3B, and similar drawings), although this is not a requirement. In some embodiments, at least one decoy channel 102 has a structure (e.g., size, shape) such that it appears to be identical to at least one operative channel 105. For example, in some embodiments, at least one decoy channel 102 and at least one operative channel 105 appear to have the same size and shape after the sprue region 107 has (optionally) been removed at block 212 of the method 200. Placement of at least one decoy channel 102 among at least one operative channel 105 and making at least one decoy channel 102 and at least one operative channel 105 the same size and shape to mask which is which can frustrate a reverse engineer's efforts to distinguish between operative channels 105 and decoy channels 102. As explained above, although including at least one decoy channel 102 can provide certain advantages, it is not a requirement to include the at least one decoy channel 102. Therefore, block 206 is optional.

At block 208, optionally, the work-in-progress microelectronic circuit package 100 is placed in a low-oxygen and/or low-humidity environment (or atmosphere), such as argon or nitrogen. Whether block 208 is performed, and whether the environment is low-oxygen, low-humidity, or both, may depend on the material selected as the reactive material 116. In the case that the reactive material 116 is NaK or RbCs, the block 208 would likely be performed to prevent a violent reaction between the reactive material 116 and oxygen and/or water present during the manufacturing process. It will be appreciated that when block 208 is performed, it is performed before the reactive material 116 is added to the sprue region 107 at block 210.

At block 210, the reactive material 116 is added to the sprue region 107. As explained above, the sprue region 107 directs the reactive material 116 into the at least one operative channel 105.

At block 212, optionally, the sprue region 107 is removed at the shear line 115. In some embodiments, such as when the at least one operative channel 105 is situated in the encapsulant 166, the sprue region 107 is not necessarily removed. Instead, the sprue region 107 and/or the at least one operative channel 105 can be covered in the encapsulant 166. Thus, the sprue region 107 can be sealed (e.g., by applying the seal 120) along with or in the same manner as the at least one operative channel 105.

It is to be appreciated that there may be intervening manufacturing steps not illustrated in FIG. 7A, such as between block 210 and block 212. For example, after block 210, a hard material that differs from the seal 120 may be deposited over the at least one operative channel 105 and/or the at least one decoy channel 102 and/or the sprue region 107. For example, the seal 120 may cover only the ends of the at least one operative channel 105 and/or the at least one decoy channel 102, or the seal 120 may be more extensive and may cover larger portions of the at least one operative channel 105 and/or the at least one decoy channel 102.

At block 214, exposed reactive material 116 is sealed (e.g., by applying the seal 120 to an exposed portion of the at least one operative channel 105, by covering an exposed portion of the at least one operative channel 105 and/or the sprue region 107 with encapsulant 166, etc.). In some embodiments, a seal 120 is applied at block 214. The seal 120 can be made of any suitable material or combination of materials that is non-reactive with the reactive material 116. As explained above, the seal 120 can comprise one or more of stainless steel, nickel, a nickel alloy, tantalum, titanium, molybdenum, glass, graphite, alumina, silicon carbide, an inert plastic (e.g., polytetrafluoroethylene (PTFE), polyetheretherketone (PEEK), etc.), 166/material, or similar. In some embodiments, encapsulant 166 material is applied to seal the exposed reactive material 116 at block 214.

At block 216, the method 200 ends.

It will be appreciated that if block 208 is performed, then block 210, block 212, and block 214 may be performed while the work-in-progress microelectronic circuit package 100 is in the low-oxygen, low-humidity environment to avoid a violent reaction. For example, if the reactive material 116 is NaK or RbCs, it is desirable to keep the work-in-progress microelectronic circuit package 100 in a substantially inert environment until after the seal 120 has been applied.

FIG. 7B is a flow diagram of a method 250 that can be performed to accomplish block 204 of the method 200 in accordance with some embodiments in which the at least one operative channel 105 is included in a die 110 of the microelectronic circuit package 100. At block 252, the method 250 begins. At block 254, at least one operative channel 105 and the sprue region 107 are etched in a wafer.

At block 256, optionally, a layer of protective material 117 can be deposited over the interior surfaces of the at least one operative channel 105 and the sprue region 107. As explained above, if present, the protective material 117 is non-reactive with the reactive material 116. Block 256 may be performed, for example, if the material of the interior surfaces of the at least one operative channel 105 and sprue region 107 is reactive with the reactive material 116.

At block 258, the method 250 ends.

FIG. 7C is a flow diagram of a method 280 that can be performed to accomplish optional block 206 of the method 200 in accordance with some embodiments in which at least one decoy channel 102 is included in a die 110 of the microelectronic circuit package 100. At block 282, the method 280 begins. At block 284, at least one decoy channel 102 is etched in a wafer. It is to be appreciated that block 284 can be combined with block 254 of the method 250. In other words, if at least one decoy channel 102 is also to be included in the microelectronic circuit package 100, the at least one decoy channel 102 can be etched into the wafer at the same time the at least one operative channel 105 and sprue region 107 are created. The at least one decoy channel 102 is non-intersecting with the at least one operative channel 105. The at least one decoy channel 102 is also non-intersecting with the sprue region 107.

At block 286, optionally, a layer of protective material 117 can be deposited over the interior surfaces of the at least one decoy channel 102. It may be desirable to perform block 286 of the method 280 if the block 256 of the method 250 is performed so that, to a reverse engineer, the at least one decoy channel 102 and the at least one operative channel 105 appear to be identical in the microelectronic circuit package 100. Alternatively, if the block 256 of the method 250 is performed (e.g., because the reactive material 116 reacts with the material in which the at least one operative channel 105 is created), it may be desirable to leave the interior surfaces of the at least one decoy channel 102 as is (e.g. protected by a mask while the protective material 117 is deposited over the at least one operative channel 105 and the sprue region 107), without the protective material 117, which can provide yet another mechanism to damage the microelectronic circuit package 100 in response to tampering. For example, as explained above, block 256 of the method 250 would typically be performed when the material in which the at least one operative channel 105 and sprue region 107 are created is reactive with the reactive material 116. Thus, if the at least one decoy channel 102, created in this same material, is left unprotected by the protective material 117, an attempt by a reverse engineer to fill the at least one decoy channel 102 with reactive material 116 will cause the reactive material 116 to react with the material of the interior of the at least one decoy channel 102, which can cause damage to the microelectronic circuit package 100.

At block 288, the method 280 ends.

The explanation of FIGS. 7B and 7C describes how at least one operative channel 105 and, if present, at least one decoy channel 102 can be created using conventional IC fabrication techniques (e.g., photolithography, doping, etching, and deposition) that are designed to create layers and structures on a silicon wafer. Thus, the at least one operative channel 105 and the at least one decoy channel 102 can be included in an microelectronic circuit package 100 in a straightforward manner, using conventional steps. It is to be appreciated, however, that there are other ways to create the at least one operative channel 105 and the at least one decoy channel 102 in the microelectronic circuit package 100. For example, microelectromechanical systems (MEMS) technology allows for the fabrication of small mechanical structures within semiconductor devices. Techniques like deep reactive ion etching (DRIE) can create three-dimensional features, including cavities. These techniques can be suitable to create the at least one operative channel 105, the sprue region 107, and/or the at least one decoy channel 102 in a die 110 or elsewhere in the microelectronic circuit package 100.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used in the specification and the appended claims, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

As used in the specification and the appended claims, phrases of the form “at least one of A, B, and C,” “at least one of A, B, or C,” “one or more of A, B, or C,” and “one or more of A, B, and C” are interchangeable, and each encompasses all of the following meanings: “A only,” “B only,” “C only,” “A and B but not C,” “A and C but not B,” “B and C but not A,” and “all of A, B, and C.”

To the extent that the terms “include(s),” “having,” “has,” “with,” and variants thereof are used in the detailed description or the claims, such terms are intended to be inclusive in a manner similar to the term “comprising,” i.e., meaning “including but not limited to.”

The terms “exemplary” and “embodiment” are used to express examples, not preferences or requirements.

The term “coupled” is used herein to express a direct connection/attachment as well as a connection/attachment through one or more intervening elements or structures.

The terms “over,” “under,” “between,” and “on” are used herein refer to a relative position of one feature with respect to other features. For example, one feature disposed “over” or “under” another feature may be directly in contact with the other feature or may have intervening material. Moreover, one feature disposed “between” two features may be directly in contact with the two features or may have one or more intervening features or materials. In contrast, a first feature “on” a second feature is in contact with that second feature.

The term “substantially” is used to describe a structure, configuration, dimension, etc. that is largely or nearly as stated, but, due to manufacturing tolerances and the like, may in practice result in a situation in which the structure, configuration, dimension, etc. is not always or necessarily precisely as stated. For example, describing two lengths as “substantially equal” means that the two lengths are the same for all practical purposes, but they may not (and need not) be precisely equal at sufficiently small scales. As another example, a structure that is “substantially vertical” would be considered to be vertical for all practical purposes, even if it is not precisely at 90 degrees relative to horizontal.

The drawings are not necessarily to scale, and the dimensions, shapes, and sizes of the features may differ substantially from how they are depicted in the drawings.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A microelectronic circuit package, comprising:
one or more operative channels, each of the one or more operative channels containing a reactive material, wherein at least one of the one or more operative channels has a maximum width of less than about 100 microns; and
a seal covering at least a portion of the one or more operative channels, wherein the seal is non-reactive with the reactive material.

2. The microelectronic circuit package recited in claim 1, wherein the reactive material is reactive with at least one of nitric acid, sulfuric acid, oxygen, or water.

3. The microelectronic circuit package recited in claim 2, wherein the reactive material comprises at least one of Li, Na, K, Rb, or Cs.

4. The microelectronic circuit package recited in claim 2, wherein the reactive material comprises an organolaluminum compound of a form A12X6, wherein X is a methyl or ethyl group.

5. The microelectronic circuit package recited in claim 1, wherein the reactive material is conductive, and further comprising wiring, wherein the reactive material in at least one of one or more operative channels is included in the wiring.

6. The microelectronic circuit package recited in claim 1, wherein at least one of the one or more operative channels is included in an integrated circuit chip of the microelectronic circuit package.

7. The microelectronic circuit package recited in claim 1, wherein at least one of the one or more operative channels is separate from an integrated circuit chip of the microelectronic circuit package.

8. The microelectronic circuit package recited in claim 1, wherein the seal comprises at least one of stainless steel, nickel, tantalum, titanium, molybdenum, glass, graphite, alumina, silicon carbide, an inert plastic, or encapsulant material.

9. The microelectronic circuit package recited in claim 1, further comprising:
at least one sensor to sense a characteristic of the reactive material in at least one of the one or more operative channels; and
a processor coupled to the at least one sensor and configured to:
obtain from the at least one sensor an indication of the sensed characteristic,
determine, based at least in part on the indication of the sensed characteristic, that the characteristic of the reactive material in the at least one of the one or more operative channels has changed, and
in response to the determination that the characteristic of the reactive material in the at least one of the one or more operative channels has changed, take an action.

10. The microelectronic circuit package recited in claim 9, wherein the characteristic is at least one of a resistance of the reactive material, a capacitance of the reactive material, a dielectric property of the reactive material, a presence of at least one random feature in the reactive material, or a configuration of the at least one random feature in the reactive material.

11. The microelectronic circuit package recited in claim 10, wherein the at least one random feature comprises one or more bubbles and/or one or more particles.

12. The microelectronic circuit package recited in claim 9, wherein the action comprises at least one of: abort a start-up procedure, prevent execution of code, prevent booting, erase or overwrite data, disable a function of an integrated circuit chip of the microelectronic circuit package, disable the integrated circuit chip, disable a communication interface of the integrated circuit chip, or blow a hardware fuse of the integrated circuit chip.

13. The microelectronic circuit package recited in claim 1, further comprising:
at least one sensor to sense a characteristic of the reactive material in at least one of the one or more operative channels; and
a processor coupled to the at least one sensor and configured to:
obtain from the at least one sensor an indication of the sensed characteristic,
based at least in part on the indication of the sensed characteristic, derive a cryptographic key usable to protect data to be stored in the microelectronic circuit package or access to the microelectronic circuit package.

14. The microelectronic circuit package recited in claim 13, wherein the processor is further configured to:
decrypt data stored in the microelectronic circuit package using the cryptographic key.

15. The microelectronic circuit package recited in claim 13, wherein the characteristic is at least one of a resistance of the reactive material, a capacitance of the reactive material, a dielectric property of the reactive material, a presence of at least one random feature in the reactive material, or a configuration of the at least one random feature in the reactive material.

16. The microelectronic circuit package recited in claim 15, wherein the at least one random feature comprises one or more bubbles and/or one or more particles.

17. The microelectronic circuit package recited in claim 13, wherein the at least one sensor comprises a sensor array situated along a length of the at least one of the one or more operative channels.

18. The microelectronic circuit package recited in claim 17, wherein the characteristic is a presence of a plurality of random features in the reactive material, or a configuration of the plurality of random features in the reactive material.

19. The microelectronic circuit package recited in claim 18, wherein the plurality of random features comprises a plurality of bubbles and/or a plurality of particles.

20. The microelectronic circuit package recited in claim 1, wherein each of the one or more operative channels is lined with a protective material, the protective material being non-reactive with the reactive material.

21. The microelectronic circuit package recited in claim 20, wherein the reactive material comprises NaK or RbCs, and wherein the protective material comprises stainless steel, nickel, tantalum, titanium, molybdenum, glass, graphite, alumina, silicon carbide, or an inert plastic.

22. The microelectronic circuit package recited in claim 1, further comprising:
one or more decoy channels, each of the one or more decoy channels having a size and shape substantially identical to a size and shape of each of the one or more operative channels,
wherein the seal covers at least one end of each of the one or more decoy channels.

23. The microelectronic circuit package recited in claim 22, wherein the one or more decoy channels are unfilled, and wherein at least one of the one or more decoy channels is configured to cause a short circuit in response to being filled with a conductive material.

24. The microelectronic circuit package recited in claim 22, wherein at least one of the one or more decoy channels is filled with a second material.

25. The microelectronic circuit package recited in claim 24, wherein the second material comprises a conductor, and further comprising wiring, wherein the second material in the at least one of the one or more decoy channels is included in the wiring.

26. A method of manufacturing a microelectronic circuit package comprising at least one operative channel containing a reactive material, the method comprising:
creating the at least one operative channel in a work-in-progress microelectronic circuit package, wherein a maximum width of the at least one operative channel is less than about 100 microns;
directing the reactive material into the at least one operative channel; and
sealing an exposed portion of the at least one operative channel, thereby covering at least some of the reactive material with a seal.

27. The method of claim 26, wherein the seal comprises at least one of stainless steel, nickel, tantalum, titanium, molybdenum, glass, graphite, alumina, silicon carbide, an inert plastic, or encapsulant material.

28. The method of claim 26, wherein directing the reactive material into the at least one operative channel is performed using a sprue region of the microelectronic circuit package, and further comprising:
creating the sprue region; and
after directing the reactive material into the at least one operative channel, removing the sprue region from the work-in-progress microelectronic circuit package at a shear line, thereby leaving an exposed surface,
and wherein sealing the exposed portion of the at least one operative channel comprises applying the seal to the exposed surface.

29. The method of claim 26, wherein the reactive material is conductive.

30. The method of claim 29, wherein the reactive material comprises at least one of Li, Na, K, Rb, or Cs.

31. The method of claim 26, further comprising placing the work-in-progress microelectronic circuit package in a low-oxygen and/or low-humidity environment before directing the reactive material into the at least one operative channel.

32. The method of claim 31, wherein sealing the exposed portion of the at least one operative channel is performed while the work-in-progress microelectronic circuit package is in the low-oxygen and/or low-humidity environment.

33. The method of claim 26, wherein creating the at least one operative channel comprises:
etching the at least one operative channel in the work-in-progress microelectronic circuit package.

34. The method of claim 33, further comprising:
depositing a layer of protective material over an interior surface of the at least one operative channel.

35. The method of claim 34, wherein the protective material is non-reactive with the reactive material.

36. The method of claim 35, wherein the reactive material is Nak or RbCs, and the protective material comprises one or more of stainless steel, nickel, tantalum, titanium, molybdenum, glass, graphite, alumina, silicon carbide, or an inert plastic.

37. The method of claim 26, further comprising:
creating one or more decoy channels in the work-in-progress microelectronic circuit package, wherein each of the one or more decoy channels is non-intersecting with the at least one operative channel; and
sealing an exposed portion of the one or more decoy channels.

38. The method of claim 37, further comprising:
depositing a layer of protective material over an interior surface of the at least one of the one or more decoy channels.

39. The method of claim 38, wherein the protective material is non-reactive with the reactive material.

40. The method of claim 39, wherein the reactive material is NaK or RbCs, and the protective material comprises one or more of stainless steel, nickel, tantalum, titanium, molybdenum, glass, graphite, alumina, silicon carbide, or an inert plastic.

41. The method of claim 37, further comprising:
before sealing the exposed portion of the one or more decoy channels, directing a second material into at least one of the one or more decoy channels.

42. The method of claim 41, wherein the second material is conductive.
